(19) United States
(12) Patent Application Publication
(10) Pub. No.: US 2004/0162021 A1
(43) Pub. Date: Aug. 19, 2004

(54) Transmitting deversity system

(76) Inventors: Hiroyuki Seki, Kawasaki (JP); Daisuke Jitsukawa, Kawasaki (JP); Yoshinori Tanaka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/699,593

(22) Filed: Oct. 30, 2003

Related U.S. Application Data
(63) Continuation of application No. PCT/JP01/03790, filed on May 2, 2001.

(51) Int. Cl. H04B 7/24

(52) U.S. Cl. 455/39

(57) ABSTRACT

Upon receipt of signals from a base station having a plurality of transmitting antennas, a mobile node measures the propagation loss, fading frequency or correlation coefficient of the signals transmitted from each antenna and notifies a base station of an antenna, the weight of which is controlled and which is used to communicate with the base station, as well as weight using an upward channel. The base station extracts the antenna selection data and control weight data transmitted from the mobile node and communicates with the mobile node while controlling the weight of the selected antenna and fixing the weight of any unselected antennas.

### CROSS REFERENCE TO RELATED APPLICATION

This application is a continuation of International PCT Application No. PCT/JP01/03790 filed on May 2, 2001.

### BACKGROUND OF THE INVENTION

1. Field of the Invention

The present invention relates to a closed-loop transmitting diversity system, and in particular, relates to a closed-loop transmitting diversity system in which the wireless base station of a cellular mobile communication system is provided with a plurality of antenna elements and different types of amplitude/phase control are applied to the same transmitting data signal according to feedback data from mobile nodes. In the system, each controlled data signal is transmitted using a different antenna and each mobile node detects the amplitude/phase control weight using a downward pilot signal. Then, each mobile node multiplexes feedback data indicating the amplitude/phase control weight onto an upward channel signal and transmits the multiplexed signal to the base station.

2. Description of the Related Art

In the transmitting diversity of W-CDMA, which is a third-generation mobile communication system, two transmitting antennas are used.

FIG. 1 shows the system configuration using two transmitting antennas.

Pilot patterns P₁ and P₂, which are orthogonal to each other are generated by a pilot signal generation unit 11 and are transmitted from the transmitting antennas 10-1 and 10-2, respectively.

A mobile node receives the transmitted pilot signals by a receiving antenna 12. Then, by correlating the receiving pilot signal with the known pilot pattern, channel impulse response vectors h₁ and h₂ to be transmitted from each transmitting antenna to the receiving antenna of the mobile node are estimated.

The amplitude/phase control vector (weight vector) w=[w₁, w₂]^{T} of each transmitting antenna of the base station in which power P expressed by equation (1) becomes a maximum, is calculated using these channel estimation values. This vector w is digitalized, is multiplexed onto an upward channel signal as feedback data and is transmitted to the base station. However, there is no need to transmit both values w₁ and w₂, and it is acceptable if only value w₂ obtained by calculating assuming w₁=1 is transmitted.

P=w^{H}H^{H}w (1)

H=[h₁, h₂] (2)

In equation (2), h₁ and h₂ are the channel impulse response vectors to be transmitted from the antennas 10-1 and 10-2, respectively, to the receiving antenna 12. If the length of impulse response is assumed to be L, the vector hₗ is expressed as follows.

hᵢ=[hᵢ₁, hᵢ₂, . . . , h_{iL}]^{T} (3)

At the time of soft handover, the control vector w in which P of equation (4) becomes a maximum instead of P of equation (1), is calculated.

P=w^{H}(H₁^{H}H₁+H₂^{H}H₂+. . . )w (4)

In equation (4), Hₖ is the channel impulse response value of a signal transmitted from the k-th base station.

In the mobile node, a weight coefficient (weight vector) is calculated by a control weight calculation unit 13 as a control weight in this way. Then, the weight coefficient is multiplexed onto main data and is transmitted to the base station from the transmitting antenna of the mobile node. In the base station, the feedback data from the mobile node is received by the receiving antenna 15. The weight coefficient, which is a control weight, is extracted by a feedback data extraction unit 16 and an amplitude/phase control unit 17 exercises control over the amplitude/phase of signals to be transmitted from the transmitting antennas 10-1 and 10-2. Thus, the mobile node can effectively receive signals transmitted from two transmitting diversity antennas 10-1 and 10-2.

In W-CDMA, two modes are stipulated: mode 1 where the weight coefficient w₂ transmitted from a mobile node to a base station is digitized as one bit and mode 2 where it is digitized as four bits. In mode 1, since control is exercised by transmitting one bit of feedback data for each slot, high control speed is obtained. Since digitization is rough, exact control cannot be exercised. However, in mode 2, control is exercised using four bits of information, and more accurate control can be exercised. Since one bit of information is transmitted for each slot and one word of feedback data is transmitted for every four slots, fading cannot be followed and a signal quality degrades if fading happens in a high frequency. As described above, if the upward channel signal transfer rate for transmitting feedback data is restricted, control accuracy and fading follow-up speed are in a trade-off relationship.

Release-99 of the W-CDMA standard does not take into consideration a case where three or more transmitting antennas are used so as to avoid the degradation of upward channel transmission efficiency due to the transmission of feedback data. However, if an increase of feedback data and a reduction of update speed are allowed, the number of transmitting antennas can be increased to three or more.

FIG. 2 shows an example configuration using four transmitting antennas.

In FIG. 2, the same reference numbers are attached to the same constituent components as those shown in FIG. 1 and their descriptions are omitted.

If the number of transmitting antennas is N (in FIG. 2, four transmitting antennas 10-1 through 10-4), a wireless base station transmits N pilot signals P₁ (t), P₂ (t), . . . , P_{N} (t) that are orthogonal to one another using N different transmitting antennas. In this case, there is the following relationship among these pilot signals.

∫Pᵢ(t)Pⱼ(t)dt=0 (i≠j) (5)

Each pilot signal suffers from amplitude/phase fluctuations due to fading, and the combination of these affected signals are received by the receiving antenna of a mobile node. The receiver of the mobile node estimates the channel impulse response vectors h₁, . . . , h₂, h_{N} by correlating the incoming pilot signal with each of P₁ (t), P₂(t), . . . , P_{N} (t).

The amplitude/phase control vector (weight vector) w=[w₁, w₂, . . . , w_{N}]^{T} of each transmitting antenna of the base station in which power P expressed by equation (6) becomes a maximum, is calculated using these channel estimation values. This vector w is digitalized, is multiplexed onto an upward channel signal as feedback data and is transmitted to the base station. However, in this case too, it is acceptable to transmit values w₂, w₃, . . . , w_{N} obtained with assumption that w₁=1.

P=w^{H}H^{H}Hw (6)

H=[h₁, h₂, . . . , h_{N}] (7)

FIG. 3 shows a detailed example configuration of a mobile node.

In FIG. 3, it is assumed that the base station has four transmitting antennas.

First, a downward data signal transmitted from the base station is received by a receiving antenna 12 and is transferred to a data channel despreading unit 20 and a pilot channel despreading unit 22. The data channel despreading unit 20 and pilot channel despreading unit 22 despread data channels and pilot channels, respectively. The despread pilot signals, which are the output of the pilot channel despreading unit 22, are input to channel estimation units 23-1 through 23-4. In order to calculate the channel estimation values of the received pilot signals, each of the known pilot signals P₁ through P₄ is compared with each received pilot signal by each of the channel estimation unit 23-1 through 23-4. Then, channel impulse response values h₁ through h₄ indicating the state of amplitude/phase modulation due to propagation of the received pilot signal are obtained and are input to a control weight calculation unit 25. Since the control weight calculation unit 25 has a weight vector to be transmitted as feedback data, the unit 25 calculates power P using this vector, calculates a weight vector providing the maximum power P and transmits the vector as feedback data.

Although each of the channel estimation units 23-1 through 23-4 calculates impulse response values of each transmitting antenna, this value is input to a channel estimation unit 24 and the entire impulse response value h is calculated. Then, this value is input to a receiver 21 and is used to demodulate the data channel. The feedback data obtained by the control weight calculation unit 25 is transferred to a multiplex unit 26, is multiplexed with an upward data signal, is modulated by a data modulation unit 27, is spread /modulated by a spreading modulation unit 28 and is transmitted from a transmitting antenna 14 as an upward data signal, including feedback data.

In particular, FIG. 3 shows a method for performing pilot-aided coherent detection using channel response vectors h₁, h₂, . . . , h_{N} calculated using the pilot channels in order to demodulate downward incoming data. In this case, channel estimation values used to perform the coherent detection of a data symbol in the receiver 21 are calculated as follows.

h=Hw (8)

In equation (8), h is the channel impulse response vector of the data channel combined in the receiving antenna of a mobile node, and the length of the vector is L.

If the wireless base station of a cellular mobile communication system adopts a closed-loop transmitting diversity, signals from each transmitting antenna independently suffer from fading and respective signals transmitted from several transmitting antennas are ideally combined in the same phase at the antenna position of the mobile node. In this case, a diversity gain can be gained in accordance with the number of transmitting antennas and also gain can be improved by combination. Therefore, receiving quality can be improved and also the number of users to be accommodated in one cell can be increased. In this case, “ideally” means that there are no errors in transmission of feedback data, control delay, channel response estimation and digitization of a control weight. In reality, the quality degrades more greatly than the ideal case due to these factors.

If the number of transmitting antennas increases, the amount of data to be fed back increases (the length of the weight vector becomes longer). Then, if the transmitted feedback data increases, the transmission efficiency of an upward channel degrades. Generally, the amount of data to be used for feedback transmission is restricted. For example, in W-CDMA, only one bit can be allocated to each slot. Therefore, control delay increases in proportion to the number of transmitting antennas, and high-speed fading cannot be followed, causing quality degradation, which is another problem.

At the time of soft handover, the number of transmitting antennas also increases in proportion to the number of handover base stations. In W-CDMA, in order to process data without increasing the amount of feedback data, amplitude/phase control of data transmitted from each base station is exercised using a weight common to all base stations as expressed in equation (4). According to this method, since respective signals transmitted from the several transmitting antennas of each base station are not optimally controlled in such a way that their phases are synchronized, a sufficient transmitting diversity effect cannot be obtained. However, in order to synchronize the phase of respective signals from the transmitting antennas in the same phase in each base station, the weight of each base station must be independently controlled. In this case, control delay increases and a signal quality degrades.

### SUMMARY OF THE INVENTION

An object of the present invention is to provide a transmitting diversity system suppressing signal quality degradation in a high fading frequency, obtaining an optimal transmitting diversity gain in accordance with the fading frequency of each mobile node and securing a sufficient transmitting diversity gain even at the time of soft handover when the number of transmitting antennas increases.

The transmitting diversity system of the present invention is adopted in a base station transmitting signals from a plurality of antennas and performing diversity transmission according to feedback data transmitted from mobile nodes receiving the signals. The system comprises a signal condition detection unit detecting the condition of a signal transmitted from each of the plurality of antennas, an antenna selection unit selecting an antenna for which a control weight is calculated, from the plurality of antennas based on the signal condition and a control weight unit calculating the control weight to be applied to the selected antenna and applying the control weight to signals transmitted from the selected antenna.

According to the present invention, since the antenna for which the control weight is calculated, is selected and controlled in the base station having a plurality of antennas, the amount of data to be fed back from a mobile node to the base station can be reduced. Conventionally, if transmitting diversity is applied using many antennas, the amount of data to be fed back becomes large and fading follow-up capability degrades. In this case, the performance obtained by using many antennas degrades more greatly than that obtained by using only two antennas. However, according to the present invention, such degradation of performance can be eliminated. Therefore, a transmitting diversity effect obtained by using many antennas can be effectively utilized and communications with better quality become available.

### BRIEF DESCRIPTION OF DRAWINGS

FIG. 1 shows a system configuration using two transmitting antennas.

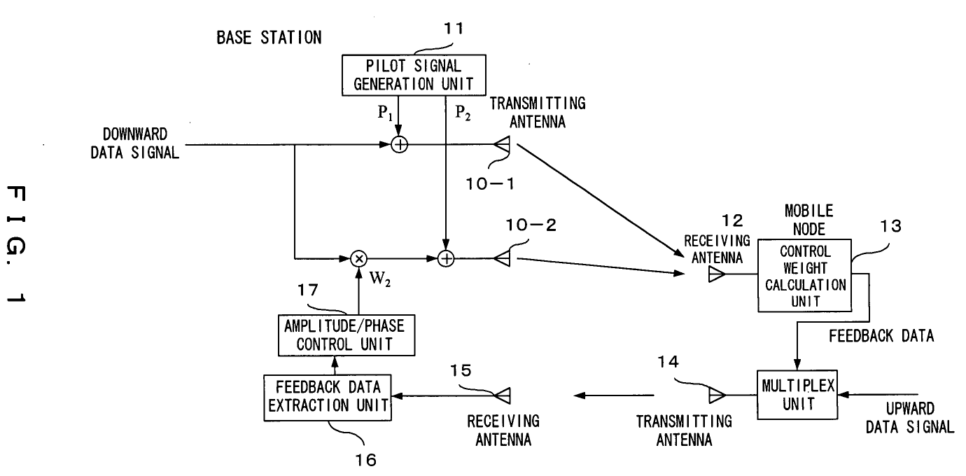

FIG. 2 shows an example configuration using four transmitting antennas.

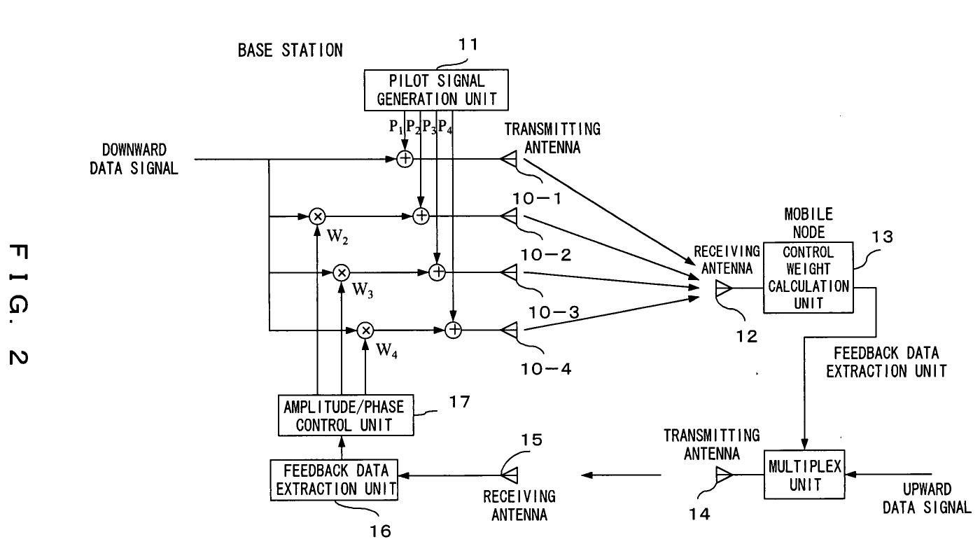

FIG. 3 shows a detailed configuration of a mobile node.

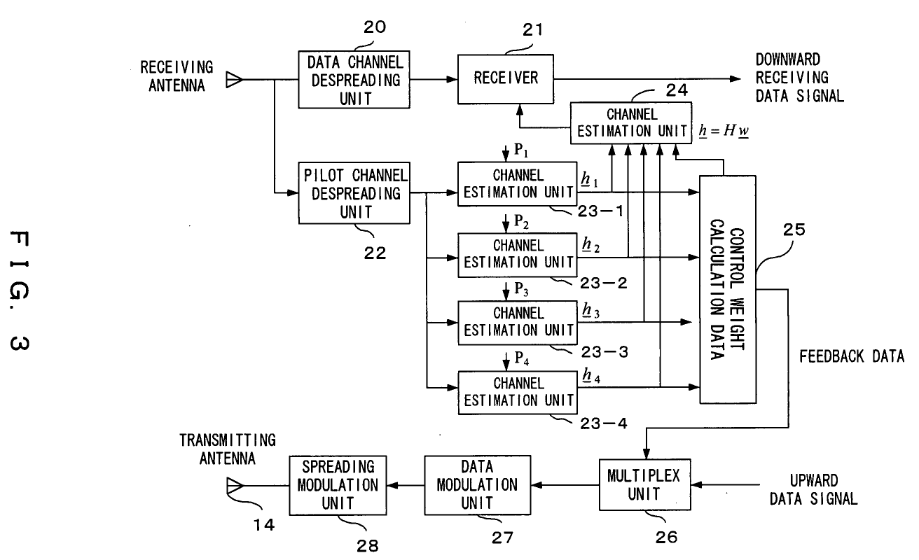

FIG. 4 shows the basic system configuration of the present invention.

FIG. 5 shows the configuration of the first preferred embodiment of the present invention.

FIG. 6 shows the configuration of the second preferred embodiment of the present invention.

FIG. 7 shows the configuration of the third preferred embodiment of the present invention.

FIG. 8 shows the configuration of the fourth preferred embodiment of the present invention.

FIG. 9 shows the configuration of the fifth preferred embodiment of the present invention.

### DESCRIPTION OF THE PREFERRED EMBODIMENTS

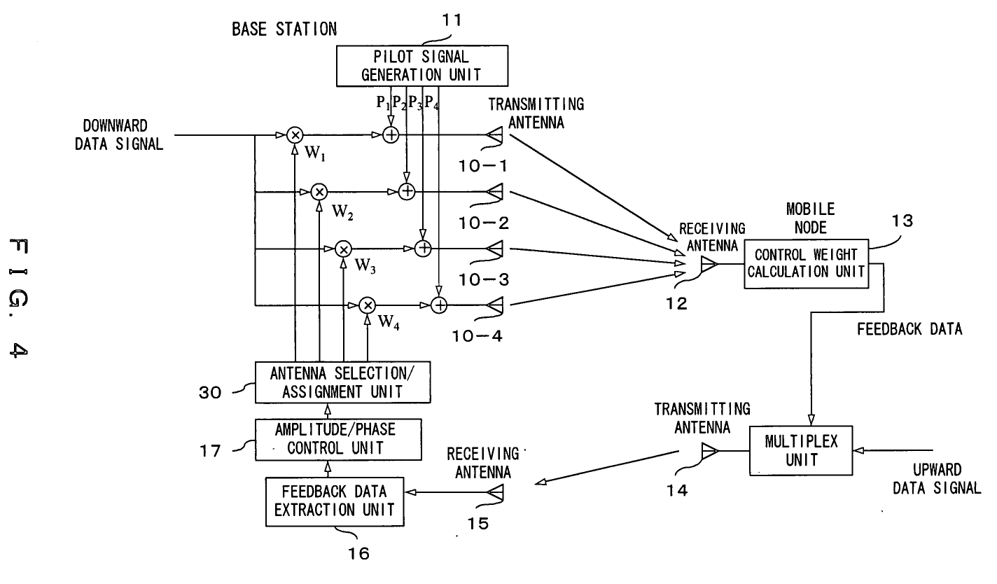

FIG. 4 shows the basic system configuration of the present invention.

In a conventional configuration, if the number of transmitting antennas is N, (N−1) weights must be fed back. Therefore, as the number of transmitting antennas increases, control delay increases. In the preferred embodiment of the present invention, data is not transmitted from all the antennas. In this case, some antennas are selected and transmitting diversity is applied to the selected antennas. Specifically, if a signal quality greatly degrades as control delay increases, control delay is suppressed by reducing the number of antennas selected. However, if a signal quality degrades little even when control delay increases, the number of antennas selected is increased and adjustments are made in such a way that a sufficient diversity gain can be obtained. In the wave propagation environment of mobile communication, signals transmitted from several antennas are seldom received with the same power by a mobile node. In reality, differences in propagation loss are caused by fading and shadowing. Not only does the power of an incoming data signal transmitted from an antenna with a great propagation loss degrade, but the estimation accuracy of a channel impulse response value and the reliability of a control weight also degrade. Therefore, even if weight control is exercised over an antenna with great propagation loss, it will not likely to contribute to an improvement in transmitting diversity gain. In this case, by preferentially selecting antennas with small propagation loss, control delay can be suppressed to a low level and also a sufficient transmitting diversity gain can be obtained. In this case, propagation loss can be easily measured by measuring a level value obtained after demodulating a pilot signal.

Furthermore, the degradation of a signal quality due to control delay also varies depending on a correlation coefficient between antennas. If the correlation coefficient between antennas is small, a signal from each antenna suffers from independent fading with low correlation. In this case, the control weight of each antenna also becomes independent and the control weight fluctuates independently as fading fluctuates. Therefore, the higher a fading frequency becomes, the shorter the modification cycle of the control weight. As a result, a signal quality degrades greatly due to control delay. However, if the correlation coefficient between antennas is large, the fading correlation between the respective signals of the antennas becomes high and the control weight correlation between the respective signals also becomes high. In this case, even if fading fluctuates, there is no great change in the relative relationship between control weights. Therefore, even when a fading frequency is high, there is no need to shorten the update cycle of a control weight and the influence of control delay is reduced. A correlation coefficient ρ between antennas (the envelope correlation coefficient between arriving waves) is expressed as follows.

$$ρ = ( \frac{sin X}{X} ) \\ X = \frac{π d Δ φ}{λ} \qquad ( 9 )$$

In equation (9), it is assumed that arriving waves are distributed uniformly with angle spread Δφ. d and λ are an antenna element interval and the wavelength of a carrier wave, respectively. Generally, in order to obtain a diversity gain, an antenna interval must be widened so that a fading correlation can become sufficiently low. It is generally observed that the angle spread of an arriving wave is approximately three degrees in a base station in a macro-cell (cell with a radius of 2 to 5 km) environment. Therefore, if the antenna interval is approximately 20 wavelengths, an envelope correlation coefficient (coefficient indicating the degree of correlation between antennas on the envelope of the changing amplitude due to fading of an incoming signal) becomes zero. However, since the angle distribution of an arriving wave changes greatly in a propagation environment, the respective signals of all mobile nodes are not always zero. Therefore, by determining the number of antennas used for diversity transmitting based on a correlation coefficient between antennas in a base station, an optimal transmitting diversity gain can be obtained in each mobile node.

In FIG. 4, pilot signals generated by a pilot signal generation unit 11 are transmitted from four transmitting antennas 10-1 through 10-4. When they are received by the receiving antenna 12 of a mobile node, a control weight is calculated by a control weight calculation unit 13, is multiplexed with an upward data signal as feedback data and is transmitted from a transmitting antenna 14 to the base station. However, in this case, the mobile or base station measures a propagation loss or the correlation coefficient between antennas, determines an antenna to be used for communication based on the coefficient, issues an instruction to an antenna selection/assignment unit 30 and controls the control weights of antennas to be used or controls in such a way that data are transmitted from antennas to be used.

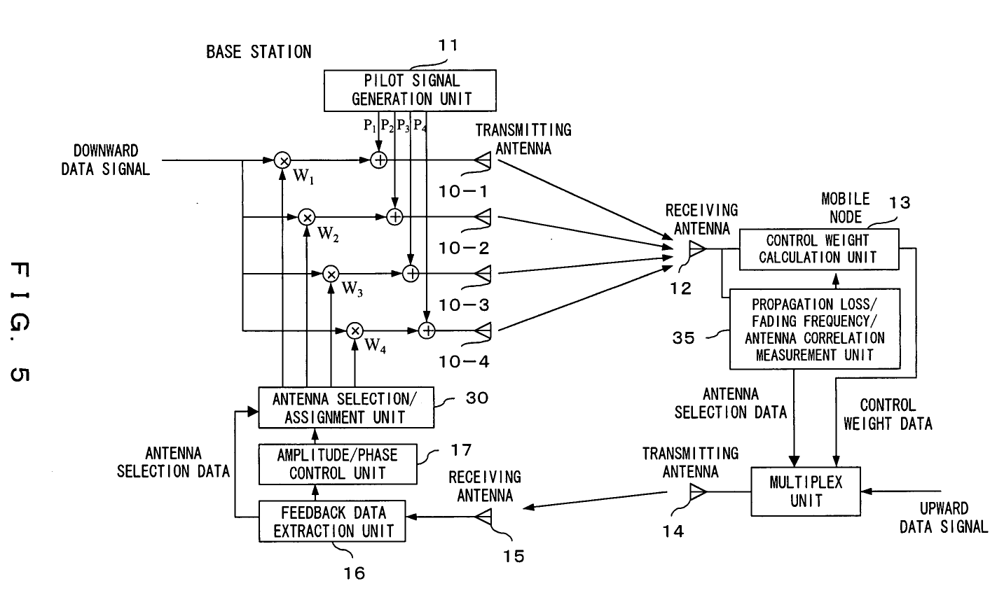

FIG. 5 shows the configuration of the first preferred embodiment of the present invention.

Pilot signals P₁(t), P₂(t), P₃(t) and P₄(t) are transmitted from the transmitting antennas 10-1 through 10-4, respectively. Mutually orthogonal sequences are used for these pilot signals. Each pilot signal suffers from amplitude/phase fluctuations due to fading and the combination of these affected signals is received by the receiving antenna 12 of a mobile node. The receiver of the mobile node calculates the channel response estimation values h₁, h₂, h₃ and h₄ for the respective pilot signals by correlating the respective incoming pilot signals to P₁(t), P₂(t), P₃(t) and P₄(t) and averaging them.

Usually, a channel response value is calculated for each update cycle of feedback data (in W-CDMA, one slot=667 μs). Each mobile node further calculates a fading frequency by averaging differences between the slots of a channel response estimation value for a long section (several tens of slots). Furthermore, each mobile node estimates a correlation coefficient between antennas by calculating the correlation value of the channel response value of each antenna. The propagation loss, fading frequency and correlation coefficient between antennas are measured by an antenna correlation measurement unit 35. Optimal antennas used for diversity transmitting and the number of such antennas are determined based on the propagation loss, fading frequency or correlation coefficient between antennas calculated in this way. The base station's transmitting antenna that meets the conditions is obtained by comparing the propagation loss, fading frequency or correlation coefficient between antennas with its threshold value. In this case, the control weight of any unselected antenna is fixed and a control weight in which power P expressed by equation (5) becomes a maximum is calculated. Specifically, the values of power P to be expressed by a limited number of bits of only the control weights of the selected antennas are calculated and a control weight providing the maximum power P is selected from them.

However, in this case, the control weight of one of the selected antennas can also be fixed. Therefore, if the number of selected antennas is M, (M−1) control weights are multiplexed onto an upward channel signal as feedback data and are transmitted to the base station. The information of each selected antenna is also multiplexed onto an upward signal and is reported to the base station. The information of each selected antenna can be transmitted, for example, by attaching a bit indicating the information to the top of the frame of an upward signal or by transmitting a special frame, including a bit indicating the information of all the frames of the upward signal, for every a plurality of frames.

In the base station, the received feedback data are extracted by a feedback data extraction unit 16 and the extracted control weight is input to an amplitude/phase control unit 17. Simultaneously, the extracted antenna selection data are reported to an antenna selection/assignment unit 30. The antenna selection/assignment unit 30 analyzes the received antenna selection data, selects an antenna corresponding to weight data to be fed back to each mobile node and controls the amplitude/phase of the antenna. There are two methods of distributing a downward data signal among antennas. One is a method where data is always transmitted to all base stations. In this case, the weight of an unselected antenna continues to be stored and only the weights of (M−1) selected antennas are controlled. Therefore, although the diversity gain itself degrades, channel estimation can be performed using pilot signals transmitted from all the antennas according to equation (8). Therefore, channel estimation can be performed fully utilizing the power of a pilot symbol. The other is a method where data signals are transmitted only from selected antennas. In this case, although the diversity gain is maximized for the selected number of antennas, calculation must be performed by assigning 0 to the weights of any unselected antennas if the channel estimation is performed using equation (8). Since channel estimation is performed using only some of the pilot signals in this way, the accuracy of channel estimation degrades. If an optimal control weight is calculated using equation (6), calculation must be performed by assigning 0 to the weights of any unselected antennas.

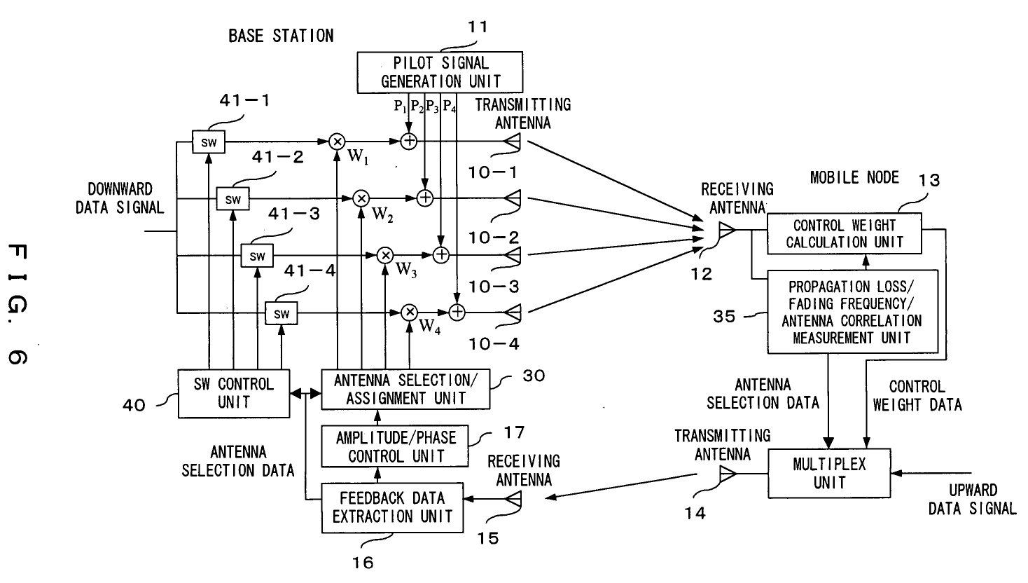

FIG. 6 shows the configuration of the second preferred embodiment of the present invention. In the configuration, only the data signals of the selected antennas are transmitted.

In FIG. 6, the same reference numbers are attached to the same constituent components as those in FIG. 5 and their descriptions are omitted.

In this preferred embodiment, in order to disconnect the output of an unselected antenna, switches 41-1 through 41-4 and a SW control unit 40 are provided for transmitting antennas 10-1 through 10-4. The antenna selection data extracted by the feedback data extraction unit 16 are reported to the SW control unit 40 as well as the antenna selection/assignment unit 30, and switches for unselected antennas of the switches 41-1 through 41-4 are turned off.

In this case, unlike the case of continuing to transmit data signals from unselected transmitting antennas, as in the preferred embodiment shown in FIG. 5, data are not transmitted from unused antennas. For this reason, although the accuracy of channel estimation degrades, the power consumption of an unused transmitting antenna can be reduced.

Since in the first and second preferred embodiments, a mobile node has the selection data of the transmitting antenna of a base station, such as propagation loss, etc., the antenna of the base station transmitting subsequent data can be specified using the data, and the demodulation and control weight calculation of incoming signals can be performed based on the data.

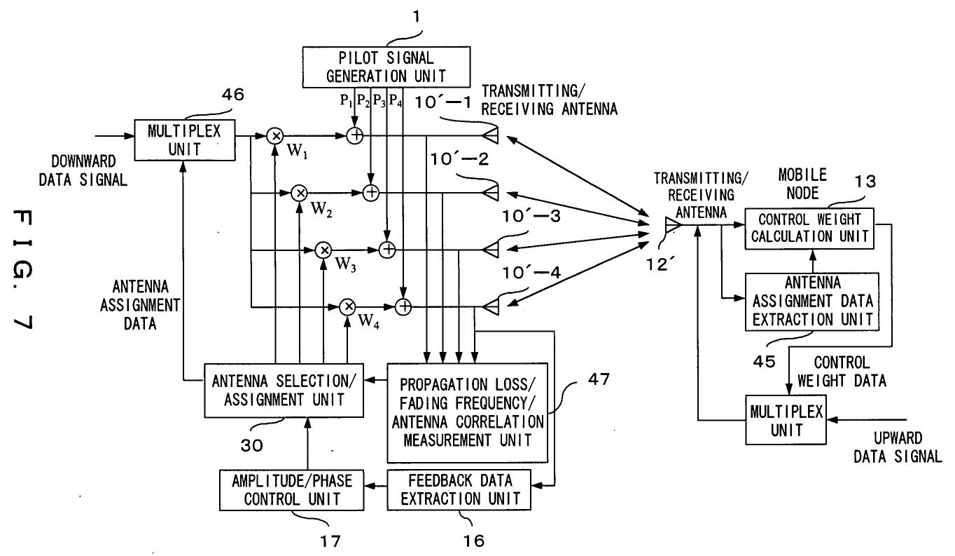

FIG. 7 shows the configuration of the third preferred embodiment of the present invention.

In FIG. 7, the same reference numbers are attached to the same constituent components as those in FIGS. 5 and 6, and their descriptions are omitted.

If in a base station, transmitting/receiving antennas 10′-1 through 10′-4 are used, the propagation line of downward signals can be estimated based on the data of a propagation line of upward signals. Even if the carrier frequencies of upward and downward signals are different, the propagation losses of upward and downward signals are almost the same. Since a fading frequency is determined by the travel speed of a mobile node, such a value can also be estimated using the incoming signal of the base station. Furthermore, by calculating a correlation between the respective signals of any two antennas of the base station, a correlation coefficient between the two antennas can be calculated. In this way, the optimal antennas to be used for transmitting diversity, and the number of antenna scan be determined by the antenna selection/assignment unit 30 based on the propagation loss, fading frequency or correlation coefficient between antennas. These values are estimated by the propagation loss/fading frequency/antenna correlation measurement unit 47 of the base station. Then, a multiplex unit 47 multiplexes the information of each selected antenna onto each downward signal being received by a mobile node. In the mobile node, the selected antennas are detected by an antenna assignment data extraction unit 45. The optimal control weight for each selected antenna is calculated by a control weight calculation unit 13. The obtained data are multiplexed onto an upward signal and the data are fed back to the base station.

In this way, if antenna selection data (propagation loss, fading frequency or correlation coefficient between antennas) is measured in the base station, an antenna to be used for transmission is selected in the base station, the selection data is reported to the mobile node and then transmission is performed using only the actually selected antennas. For the transmitting method using the selected antennas, the methods used in the first and second preferred embodiments can also be used.

At the time of soft handover, the method of controlling the weight of an antenna in such a way that respective signals transmitted from the four transmitting antennas of each base station can have the same phase is optimal. In this case, a control vector in which the power of the equation (6) becomes a maximum is calculated for each base station.

In equation (6), H can be measured from impulse response vectors h₁, h₂, . . . , hN of each transmitting antenna of soft handover base stations. At the time of soft handover, the case where there are 2 base stations each having 2 transmitting antennas can be handled by the same way as there is one base station having 4 transmitting antennas. However, according to this method, the amount of feedback data must be increased in proportion to the number of handover base stations, and if a fading frequency is high, a signal quality degrades. For this reason, the antenna weight control of each base station is conventionally exercised using a common weight vector as shown in equation (4).

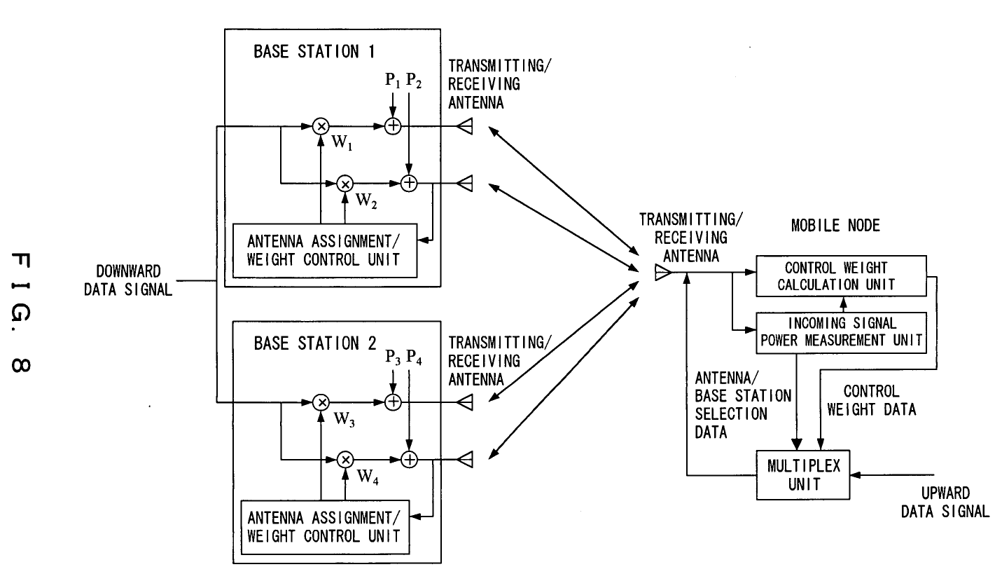

FIG. 8 shows the configuration of the fourth preferred embodiment of the present invention.

FIG. 8 shows a case where soft handover is performed between two base stations, and each base station is provided with two transmitting/receiving antennas. In this case, it is enough if in a base station 1, w₁ is fixed and w₂ is controlled, and if in a base station 2, both w₃ and w₄ are controlled. In each base station, the methods used in the first through third preferred embodiments can also be used.

Specifically, if a fading frequency is low or an antenna correlation coefficient is high, a controlled weight changes slowly. Therefore, it is enough if w₂ through w₄ are multiplexed onto an upward data signal in order of w₂, w₃ and then w₄, and the data are fed back. However, if the fading frequency is high or the antenna correlation coefficient is low, a controlled weight changes rapidly. Therefore, the amount of feedback data must be reduced. In this case, this selection data is reported to the base station and transmitting diversity is performed using only actually selected antennas.

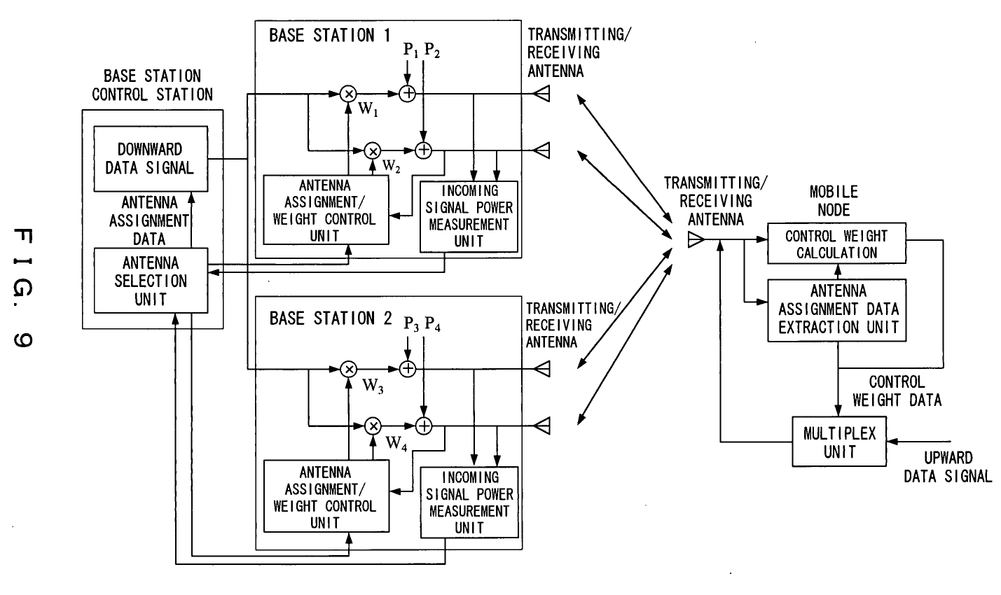

FIG. 9 shows the configuration of the fifth preferred embodiment of the present invention.

This is the configuration of a case where, in the fourth preferred embodiment, the incoming signal receiving power is measured in a base station. As in the fourth preferred embodiment, if a fading frequency is low or an antenna correlation coefficient is high, a controlled weight changes slowly. Therefore, w₂ through w₄ are multiplexed onto an upward data signal in order of w₂, w₃ and then w₄, and the data are fed back to each mobile node. However, if the fading frequency is high or the antenna correlation coefficient is low, a controlled weight changes rapidly. Therefore, it is controlled in such a way that the amount of feedback data can be reduced. In this case, each base station selects an antenna to be used based on its propagation loss, the selection data is reported to a mobile node and then transmitting diversity is performed using only actually selected antennas.

In this case, an unselected antenna can also be handled by the methods used in the first and second preferred embodiments.

If in order to select an antenna used to perform transmitting diversity, the number of transmitting antennas is increased and the following effects can be obtained.

(1) The increase in the amount of upward feedback data can be suppressed.

(2) In the case of a high fading frequency, signal quality degradation can be reduced.

(3) An optimal diversity gain corresponding to a fading frequency can be obtained.

(4) Even at the time of soft handover, a sufficient diversity gain can be secured.

What is claimed is:

1. A transmitting diversity system with a base station transmitting signals from a plurality of antennas and performing diversity transmission according to feedback data transmitted from a mobile node receiving the signals, comprising:
a signal condition detection unit detecting the condition of a signal transmitted from each of the plurality of antennas;
an antenna selection unit selecting an antenna for which a control weight is calculated, from the plurality of antennas; and
a control weight unit calculating a control weight applied to the selected antenna and applying the control weight to signals transmitted from the selected antenna.

2. The transmitting diversity system according to claim 1, wherein said control weight unit fixes the control weight of an unselected antenna.

3. The transmitting diversity system according to claim 1, further comprising
a switch unit routing input signals to each of the plurality of antennas and disconnecting the antenna, wherein
said antenna selection unit turns off a corresponding switch so that no signals can be transmitted from an unselected antenna.

4. The transmitting diversity system according to claim 1, wherein said signal condition detection unit measures propagation loss, fading frequency or correlation coefficient between antennas of an incoming signal.

5. The transmitting diversity system according to claim 1, wherein said signal condition detection unit is provided for the mobile node.

6. The transmitting diversity system according to claim 1, wherein said signal condition detection unit is provided for the base station.

7. The transmitting diversity system according to claim 1, wherein
the plurality of antennas are provided for a plurality of base stations, and
said antenna selection unit also selects a base station to communicate with by selecting an antenna with a controlled weight from the plurality of antennas and making possible a handover process accompanying the travel of each mobile node.

8. A transmitting diversity method with a base station transmitting signals from a plurality of antennas and performing diversity transmission according to feedback data transmitted from a mobile node receiving the signals, comprising:
detecting the condition of a signal transmitted from each of the plurality of antennas;
selecting an antenna for which a control weight is calculated, from the plurality of antennas; and
calculating a control weight applied to the selected antenna and applying the control weight to signals transmitted from the selected antenna.

9. The transmitting diversity method according to claim 8, wherein in the control weight step, the control weight of an unselected antenna is fixed.

10. The transmitting diversity method according to claim 8, further comprising
routing input signals to each of the plurality of antennas and disconnecting the antenna (switch step), wherein
in the antenna selection step, a corresponding switch is turned off so that no signals can be transmitted from an unselected antenna.

11. The transmitting diversity method according to claim 8, wherein in the signal condition detection step, propagation loss, fading frequency or correlation coefficient between antennas of an incoming signal is measured.

12. The transmitting diversity method according to claim 8, wherein the signal condition detection step is performed in the mobile node.

13. The transmitting diversity method according to claim 8, wherein the signal condition detection step is performed in the base station.

14. The transmitting diversity method according to claim 8, wherein
the plurality of antennas are provided for a plurality of base stations, and
in the antenna selection step, a base station to communicate with is also selected by selecting an antenna with a controlled weight from the plurality of antennas and making possible a handover process accompanying the travel of a mobile node.
